(19) United States
(12) Patent Application Publication
(10) Pub. No.: US 2011/0053009 A1
(43) Pub. Date: Mar. 3, 2011

(54) CUSTOMIZED WATER VAPOR TRANSFER MEMBRANE LAYERED STRUCTURE

(75) Inventors: Annette M. Brenner, Honeoye falls, NY (US); Timothy J. Fuller, Pittsford, NY (US); Sean M. Mackinnon, Fairport, NY (US)

(73) Assignee: GM GLOBAL TECHNOLOGY OPERATIONS, INC., Detroit, MI (US)

(21) Appl. No.: 12/549,896

(22) Filed: Aug. 28, 2009

(51) Int. Cl. H01M 8/04; H01M 2/08

(52) U.S. Cl. 429/413; 429/457

(57) ABSTRACT

A membrane humidifier assembly includes a first flow field plate adapted to facilitate flow of a first gas thereto and a second flow field plate adapted to facilitate flow of a second gas thereto. A polymeric membrane is disposed between the first and second flow fields. The polymeric membrane is adapted to permit transfer of water between the first flow field plate and the second flow field plate. The polymeric membrane includes a polymeric substrate and a polymer layer disposed on the polymeric substrate. The polymer layer characteristically includes a first polymer having fluorinated cyclobutyl groups disposed on the polymeric substrate.

### TECHNICAL FIELD

The invention relates to a fuel cell and more particularly to humidification of fuel cells.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”), to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

The internal membranes used in fuel cells are typically maintained in a moist condition. This helps avoid damage to or a shortened life of the membranes, as well as to maintain the desired efficiency of operation. For example, lower water content of the membrane leads to a higher proton conduction resistance, thus resulting in a higher ohmic voltage loss. The humidification of the feed gases, in particular the cathode inlet, is desirable in order to maintain sufficient water content in the membrane, especially in the inlet region. Humidification in a fuel cell is discussed in commonly owned U.S. patent application Ser. No. 10/797,671 to Goebel et al.; commonly owned U.S. patent application Ser. No. 10/912,298 to Sennoun et al.; and commonly owned U.S. patent application Ser. No. 11/087,911 to Forte, each of which is hereby incorporated herein by reference in its entirety.

To maintain a desired moisture level, an air humidifier is frequently used to humidify the air stream used in the fuel cell. The air humidifier normally consists of a round or box type air humidification module that is installed into a housing of the air humidifier. Examples of this type of air humidifier are shown and described in U.S. patent application Ser. No. 10/516,483 to Tanihara et al., and U.S. Pat. No. 6,471,195, each of which is hereby incorporated herein by reference in its entirety.

Membrane humidifiers have also been utilized to fulfill fuel cell humidification requirements. For the automotive fuel cell humidification application, such a membrane humidifier needs to be compact, exhibit low pressure drop, and have high performance characteristics.

Designing a membrane humidifier requires a balancing of mass transport resistance and pressure drop. To transport water from wet side to dry side through a membrane, water molecules must overcome some combination of the following resistances: convectional mass transport resistance in the wet and dry flow channels; diffusion transport resistance through the membrane; and diffusion transport resistance through the membrane support material. Compact and high performance membrane humidifiers typically require membrane materials with a high water transport rate (i.e. GPU in the range of 10,000-12,000). GPU or gas permeation unit is a partial pressure normalized flux where 1 GPU=10⁻⁶ cm³ (STP)/(cm² sec cm Hg). As a result, minimizing the transport resistance in the wet and dry flow channels and the membrane support material becomes a focus of design.

Accordingly, there is a need for improved materials and methodologies for humidifying fuel cells.

### SUMMARY OF THE INVENTION

The present invention solves one or more problems of the prior art by providing in at least one embodiment a membrane humidifier assembly. The membrane humidifier assembly includes a first flow field plate adapted to facilitate flow of a first gas thereto and a second flow field plate adapted to facilitate flow of a second gas thereto. A polymeric membrane is disposed between the first and second flow fields. The polymeric membrane is adapted to permit transfer of water between the first flow field plate and the second flow field plate. The polymeric membrane includes a polymeric substrate and a polymer layer disposed on the polymeric substrate. The polymer layer characteristically includes a first polymer having fluorinated cyclobutyl groups disposed on the polymeric substrate.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 provides a schematic of a fuel cell system including a membrane humidifier assembly for humidifying a cathode inlet airflow to a fuel cell stack;

FIG. 2A is a schematic cross section of a membrane humidifier assembly perpendicular to the flow of gas to a first flow field plate;

FIG. 2B is a cross section of a membrane humidifier assembly with a peripheral sealing edge;

FIG. 3 is a schematic cross section of a membrane humidifier assembly perpendicular to the cross section of FIG. 2A;

FIG. 4 is a schematic cross section of a variation of a membrane humidifier assembly perpendicular to the flow of gas to a first flow field plate;

FIG. 5 is a flow chart illustrating the preparation of a polymeric membrane useful in a membrane humidifier;

FIG. 6A is a schematic cross section of a polymer membrane comprising a single layer;

FIG. 6B is a schematic cross section of a polymer membrane comprising a substrate coated with a selective polymeric layer;

FIG. 6C is a schematic cross section of a polymer membrane comprising two substrates, each individually coated with a selective polymeric layer; and

FIG. 7 is a bar chart providing performance results for humidifiers incorporating embodiments of the invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

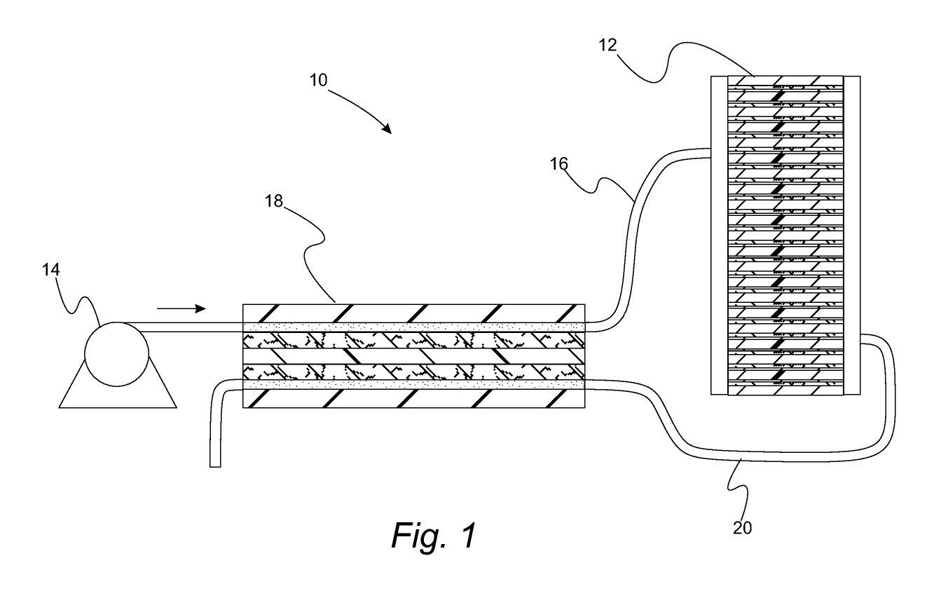

With reference to FIG. 1, a schematic of a fuel cell system incorporating a membrane humidifier assembly is provided. Fuel cell system 10 includes fuel cell stack 12. Compressor 14 provides a flow of air to the cathode side of the stack 12 on a cathode input line 16. The flow of air from the compressor 14 is sent through membrane humidifier assembly 18 to be humidified. A cathode exhaust gas is output from the stack 12 on a cathode output line 20. The cathode exhaust gas includes a considerable amount of water vapor and/or liquid water as a by-product of the electrochemical process in the fuel cell stack 12. As is well understood in the art, the cathode exhaust gas can be sent to membrane humidifier assembly 18 to provide the humidification for the cathode inlet air on the line 16.

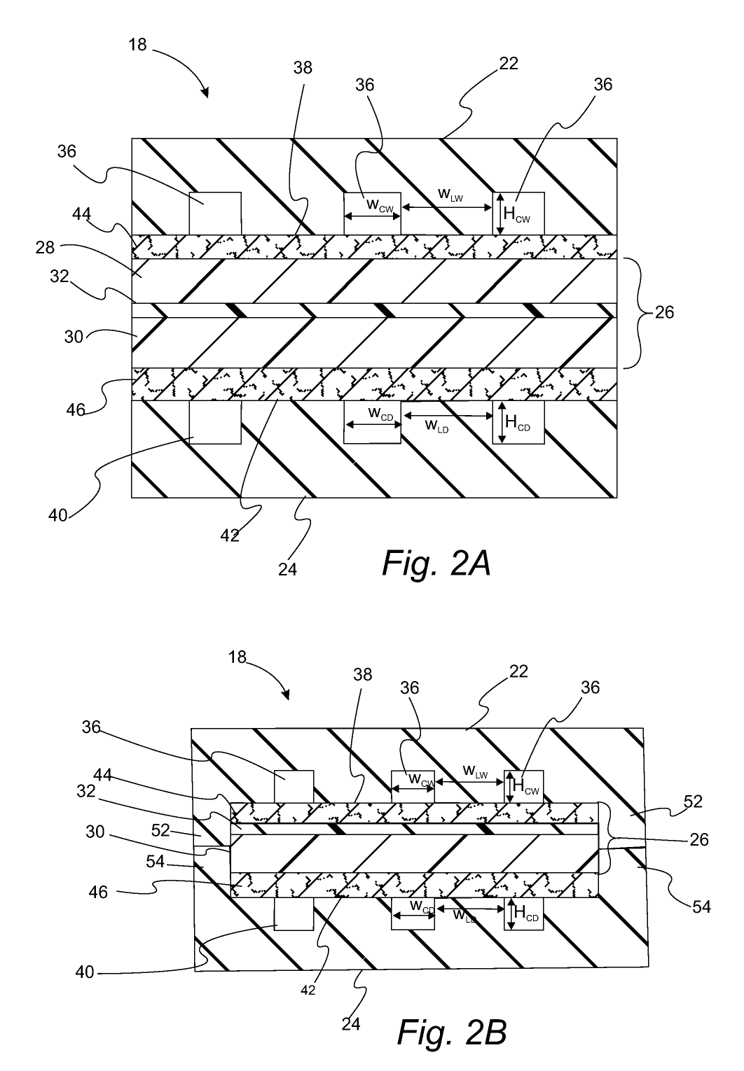

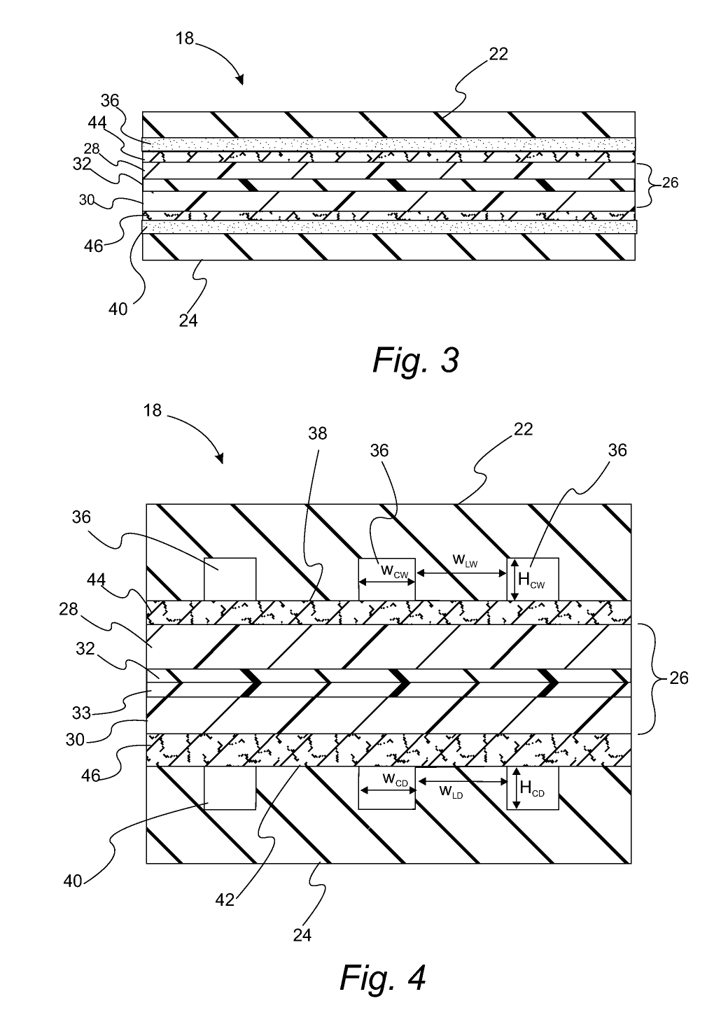

With reference to FIGS. 2A, 2B, and 3, schematic cross sections of a membrane humidifier assembly are provided. The membrane humidifier of this embodiment may be used in any application in which it is desirable to transfer water from a wet gas to a dry gas such as the fuel cell system of FIG. 1. FIG. 2A is a cross section of a membrane humidifier assembly perpendicular to the flow at which dry gas is introduced. FIG. 2B is a cross section of a membrane humidifier assembly with a peripheral sealing edge. FIG. 3 is a cross section of a membrane humidifier assembly perpendicular to the cross section of FIG. 2A. Membrane humidifier assembly 18 includes first flow field plate 22 adapted to facilitate flow of a first gas to membrane humidifier assembly 18. Membrane humidifier assembly 18 also includes second flow field plate 24 adapted to facilitate flow of a second gas thereto. In a refinement, first flow field plate 22 is a wet plate and second flow field plate 24 is a dry plate. Polymeric membrane 26 is disposed between the first flow field plate 22 and second flow field plate 24. In one variation, polymeric membrane 26 includes polymeric substrates 28 and 30 and selective polymeric layer 32. In a refinement, polymeric substrates 28 and 30 spatially vary in hydrophilicity and strength to capitalize on the pressure difference in humidifier assembly 20 and water vapor transfer. These substrates can also be customized for the adhesive used in the final device manufacturing. In another refinement, selective polymeric layer 32 spatially varies in composition yielding different strength and water vapor transfer characteristics. Selective polymeric layer 32 includes a polymer having fluorinated cyclobutyl groups (e.g., perfluorocyclobutyl groups) as set forth below in more detail. In a refinement of the present embodiment, polymeric membrane 26 has a permeance of equal to or greater than 6000 GPU, and typically in the range of 6000-16,000 GPU. Polymeric membrane 26 is adapted to permit transfer of water from the first gas to the second gas. For the embodiment shown and described herein, the membrane humidifier assembly 18 for a cathode side of the fuel cell is described. However, it is understood that the membrane humidifier assembly 18 can be used for an anode side of the fuel cell or otherwise as desired. It should be appreciated that in a variation, a membrane humidifier assembly is provided in which the membrane of U.S. Pat. Appl. No. 20080001313 is replaced by polymeric membrane 26. The entire disclosure of this patent application is hereby incorporated by reference.

First flow field plate 22 includes a plurality of flow channels 36 formed therein. The channels 36 are adapted to convey a wet gas from the cathode of the fuel cell to an exhaust (not shown). In a refinement of the present embodiment, channels 36 are characterized by a width W_{CW} and a depth H_{CW}. A land 38 is formed between adjacent channels 36 in flow field plate 22. The land 38 includes a width W_{LW}. It should be appreciated that any conventional material can be used to form the first flow field plate 22. Examples of useful materials include, but are not limited to, steel, polymers, and composite materials, for example.

Second flow field plate 24 includes a plurality of flow channels 40 formed therein. The channels 40 are adapted to convey a dry gas from a source of gas (not shown) to the cathode of the fuel cell. As used herein, wet gas means a gas such as air and gas mixtures of O₂, N₂, H₂O, H₂, and combinations thereof, for example, that include water vapor and/or liquid water therein at a level above that of the dry gas. Dry gas means a gas such as air and gas mixtures of O₂, N₂, H₂O, and H₂, for example, absent water vapor or including water vapor and/or liquid water therein at a level below that of the wet gas. It is understood that other gases or mixtures of gases can be used as desired. Channels 40 include a width W_{CD} and a depth H_{CD}. A land 42 is formed between adjacent channels 40 in second flow field plate 24. The land 42 includes a width W_{LD}. It should be appreciated that any conventional material can be used to form the dry plate 24 such as steel, polymers, and composite materials, for example.

In a refinement of the present embodiment, W_{CW} and W_{CD} are each independently from about 0.5 mm to about 5 mm. In another refinement, W_{LW} and W_{LD} are each independently from about 0.5 mm to about 5 mm. In still another refinement, H_{CW} and H_{CD} are each independently from about 0.1 to about 0.5 mm. In another refinement, H_{CW}, H_{CD} are each about 0.3 mm.

Still referring to FIGS. 2A, 2B, and 3, a diffusion medium or diffusion layer 44 is disposed adjacent the first flow field plate 22 and abuts the lands 38 thereof. Similarly, a diffusion medium or diffusion layer 46 is disposed adjacent the dry side plate 24 and abuts the lands 42 thereof. The diffusion media 44, 46 are formed from a resilient and gas permeable material such as carbon fabric, paper, polyester and glass fiber, for example. In a refinement of the present invention, diffusion media 44, 46 each independently have a thickness from about 0.05 to about 0.2 mm. In another variation, media 44, 46 each independently have a thickness from about 0.05 to about 0.15 mm. In still another variation, media 44, 46 each independently have porosity in the range of 50-95%. In yet another variation, media 44, 46 each independently have porosity from about 79 to about 90%. In another refinement, diffusion media 44, 46 are characterized by pores having a pore size from about 0.01 to about 100 micrometers. In another refinement, the pore size is from about 1 to about 50 micrometers. To mitigate against intrusion of the diffusion media 44, 46 into the channels 36, 40, which results in higher pressure drops in the channels 36, 40, it is desirable for the diffusion media 44, 46 to have a modulus of elasticity larger than 40,000 kPa, and more desirable to for the modulus to be larger than 100,000 kPa.

In another variation as set forth in FIG. 2B, the first flow field plate 22 includes peripheral sealing section 52 and the second flow field plate 24 includes peripheral sealing section 54. In a refinement, sealing surface 52 completely surrounds flow field plate 22 and sealing surface 52 completely surrounds flow field plate 24.

Membrane humidifier assembly 18 advantageously allows the transfer of water from wet side channels 36 to the dry side channels 40. Although operation of the present invention is not restricted to any particular theory of operation, several transport modes are believed to be involved in the functioning of membrane humidifier assembly 18. Convection mass transport of water vapor occurs in the channels 36, 40 while diffusion transport occurs through the diffusion media 44, 46. Water vapor is also transported by diffusion through the polymeric membrane 26. Additionally, if a pressure differential exists between the channels 36 and channels 40, water is transferred through polymeric membrane 26 by hydraulic forces. Temperature differences between the channels 36 and channels 40 may also affect the transport of water. Finally, there is also an enthalpy exchange between the channels 36 of the wet side plate 22 and the channels 40 of the dry side plate 24.

During operation, the wet gas is caused to flow through the channels 36 formed in first flow field plate 22. The wet gas is received from a supply of wet gas. Any conventional means can be used to deliver the wet gas to the channels 36 such as a supply header in communication with the channels 36, for example. In the embodiment depicted in FIG. 1, the wet gas is supplied from an exhaust stream from fuel cell stack 12. The wet gas exits the channels 36 to the exhaust. The dry gas is caused to flow through the channels 40 formed in second flow field plate 24. Any conventional means can be used to deliver the dry gas to the channels 40 such as a supply header in communication with the channels 40, for example. The dry gas then exits the channels 40. In the embodiment depicted in FIG. 1, the dry gas is supplied from compressor 14 (not shown).

In a variation of the present embodiment, the temperature of the wet gas is typically lower than the temperature of the dry gas. The temperature of the dry air from the compressor may be about 180 degrees Celsius, and the temperature of the wet air from the fuel cell exhaust may be about 80-95 degrees Celsius. If an air cooler (not shown) is used to cool the dry air supplied from the compressor, the temperature may be in the range of 95-105 degrees Celsius. It is understood that other temperature ranges can be used without departing from the scope and spirit of the invention. As a result of the temperature difference between the wet gas and the dry gas, the dry gas is also cooled during the humidification thereof. The cooling effect also increases the relative humidity of the newly humidified gas (the dry gas), thus minimizing a drying effect of the gas on components of the fuel cell.

During flow of the wet gas through the channels 36 and the flow of the dry gas through the channels 40, the wet gas is in cross flow with the dry gas. It is understood that a counter-flow of the gas streams can also be used to facilitate a transport of water vapor from wet gas stream to the dry gas stream. For a fuel cell humidification application, the water transfer effectiveness requirement is typically low. As a result, there is little expected performance difference between counter-flow and cross-flow design.

It is useful to characterize the construction of membrane humidifier assembly 20 by defining a channel area ratio ARC by the following equation:

AR_{C}=W_{C}/(W_{C}+W_{L})

where W_{C} is a channel width and W_{L} is a channel depth. In a variation, the channel area ratios AR are in the range of 75-85% with a channel width W_{C} of between 0.5 mm and 5 mm and channel depths between 0.1 mm and 0.5 mm. Such channel area ratios AR and channel widths W_{C} are chosen to maximize a membrane area utilization under the lands 38, 42 and minimize the intrusion of the membrane 26 or other structures into the flow channels 36, 40. In a refinement, flow of gas through the channels 36, 40 is laminar thereby minimizing the pressure drop through the channels 36, 40 while maximizing the water vapor transport through the diffusion media 44, 46 and the membrane 26. In another variation, the flow is turbulent through channels 36, 40.

With reference to FIG. 4, a variation of a membrane humidifier assembly is provided. FIG. 4 is a cross section of a membrane humidifier assembly perpendicular to the flow at which dry gas is introduced. Membrane humidifier assembly 18 includes first flow field plate 22 adapted to facilitate flow of a first gas to membrane humidifier assembly 18. Membrane humidifier assembly 18 also includes second flow field plate 24 adapted to facilitate flow of a second gas thereto. In a refinement, first flow field plate 22 is a wet plate and second flow field plate 24 is a dry plate. Polymeric membrane 26 is disposed between the first flow field plate 22 and second flow field plate 24. In the present variation, polymeric membrane 26 includes polymeric substrates 28 and 30 and selective polymeric layers 32, 33. In a refinement, polymeric substrates 28 and 30 spatially vary in hydrophilicity and strength to capitalize on the pressure difference in humidifier assembly 18 and water vapor transfer. These substrates can also be customized for the adhesive used in the final device manufacturing. In another refinement, selective polymeric layers 32, 33 spatially vary in composition yielding different strength and water vapor transfer characteristics. Selective polymeric layers 32, 33 each independently include a polymer having perfluorocyclobutyl groups as set forth below in more detail. In a refinement of the present embodiment, polymeric membrane 26 has a permeance of equal to or greater than 6000 GPU, and typically in the range of 6000-16,000 GPU. Polymeric membrane 26 is adapted to permit transfer of water from the first gas to the second gas. For the embodiment shown and described herein, the membrane humidifier assembly 18 for a cathode side of the fuel cell is described. However, it is understood that the membrane humidifier assembly 18 can be used for an anode side of the fuel cell or otherwise as desired. It should be appreciated that in a variation, a membrane humidifier assembly is provided in which the membrane of U.S. Pat. Appl. No. 20080001313 is replaced by polymeric membrane 26. The entire disclosure of this patent application is hereby incorporated by reference. Membrane humidifier assembly 18 also includes diffusion media 44, 46 as set forth above. Moreover, the construction of first flow field plate 22 and second flow field plate 24 is the same as that set forth above.

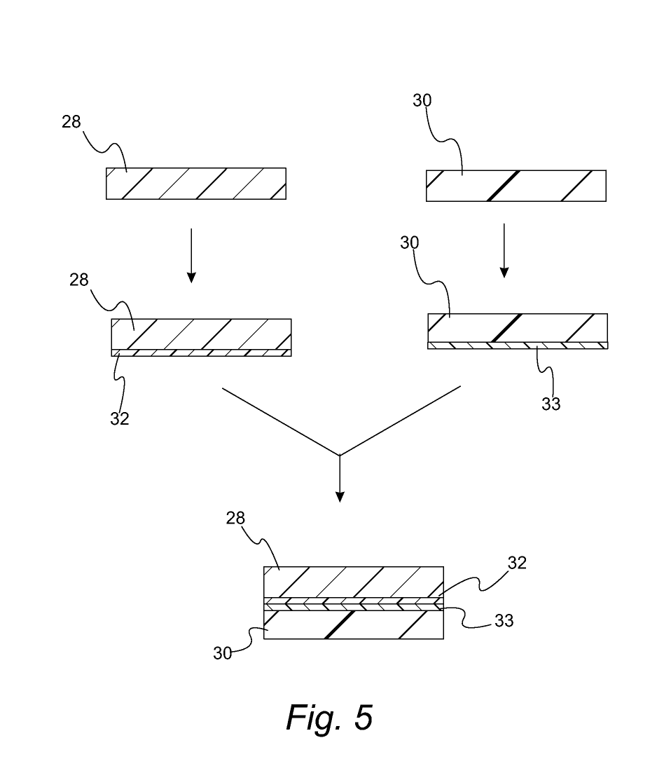

With reference to FIG. 5, a schematic flow chart illustrating a method of forming the polymeric membranes set forth above is provided. Assembly methods can vary to optimize cost, durability, and performance. Layers can be annealed individually or together. Layers can be wet or dry hot pressed. In this variation, polymeric substrate 28 is coated with a liquid precursor to polymeric layer 32. Polymeric layer 32 at least partially penetrates into substrate 28. Similarly, polymeric substrate 30 is coated with a liquid precursor to polymeric layer 33. Polymeric layer 33 at least partially penetrates into substrate 28. Each of polymeric substrates 28, 30 include sufficient porosity so that the liquid precursors to polymer layers 32, 33 are imbibed therein during formation. Therefore, polymeric substrates 28, 30 are each characterized by a predetermined void volume. Typically, the void volume is from 30 volume percent to 95 volume percent of the total volume of the substrates. Polymeric substrates 28, 30 may be formed from virtually any polymeric material having the requisite void volume. Expanded polytetrafluoroethane (ePTFE) is particularly useful for this application. In a variation, when the compositions of layers 32 and 33 are substantially the same, the embodiment of FIGS. 2A, 2B and 3 is obtained.

As set forth above, polymeric layers 32, 33 each include a polymer having perfluorocyclobutyl groups. As set forth above, polymeric membrane 26 includes a first polymer having perfluorocyclobutyl groups. Suitable polymers having cyclobutyl moieties are disclosed in U.S. Pat. Pub. No. 2007/0099054, U.S. patent application Ser. No. 12/197,530 filed Aug. 25, 2008; Ser. No. 12/197,537 filed Aug. 25, 2008; Ser. No. 12/197,545 filed Aug. 25, 2008; and Ser. No. 12/197,704 filed Aug. 25, 2008; the entire disclosures of which are hereby incorporated by reference. In a variation, the first polymer has a polymer segment comprising polymer segment 1:

E₀-P₁-Q₁-P₂ 1

wherein:

Eₒ is a moiety having a protogenic group such as —SO₂X, —PO₃H₂, or —COX;

P₁, P₂ are each independently absent, —O—, —S—, —SO—, —CO—, —SO₂—, —NR₁H—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

X is an —OH, a halogen, an ester, or

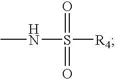

R₄ is trifluoromethyl, C₁₋₂₅ alkyl, C₁₋₂₅ perfluoroalkylene, C₁₋₂₅ aryl, or E₁ (see below); and

Q₁ is a fluorinated cyclobutyl moiety.

In variation of the present invention, the first polymer comprises polymer segments 2 and 3:

[E₁(Z₁)_{d}]-P₁-Q₁-P₂ 2

E₂-P₃-Q₂-P₄ 3

wherein:

Z₁ is a protogenic group such as —SO₂X, —PO₃H₂, —COX, and the like;

E₁ is an aromatic containing moiety;

E₂ is an unsulfonated aromatic-containing and/or aliphatic-containing moiety;

X is an —OH, a halogen, an ester, or

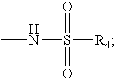

d is the number of Z₁ attached to E₁;

P₁, P₂, P₃, P₄ are each independently: absent, —O—, —S—, —SO—, —CO—, —SO₂—, —NR₁H—, NR₂—, or —R₃—;

R₂ is C₁₋₂₅ alkyl, C₁₋₂₅ aryl or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁, Q₂ are each independently a fluorinated cyclobutyl moiety. In one refinement, d is equal to the number of aromatic rings in E₁. In another refinement, each aromatic ring in E₁ can have 0, 1, 2, 3, or 4 Z₁ groups.

In another variation of the present embodiment, the first polymer comprises segments 4 and 5:

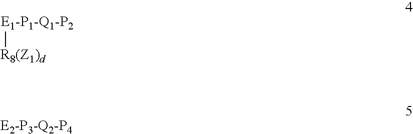

wherein:

Z₁ is a protogenic group such as —SO₂X, —PO₃H₂, —COX, and the like;

E₁, E₂ are each independently an aromatic-containing and/or aliphatic-containing moiety;

X is an —OH, a halogen, an ester, or

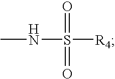

d is the number of Z₁ attached to R₈;

P₁, P₂, P₃, P₄ are each independently: absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group;

R₈(Z₁)_{d} is a moiety having d number of protogenic groups; and

Q₁, Q₂ are each independently a fluorinated cyclobutyl moiety. In a refinement, R₈ is C₁₋₂₅ alkylene, C₁₋₂₅ perfluoroalkylene, perfluoroalkyl ether, alkylether, or C₁₋₂₅ arylene. In one refinement, d is equal to the number of aromatic rings in R₈. In another refinement, each aromatic ring in R₈ can have 0, 1, 2, 3, or 4 Z₁ groups. In still another refinement, d is an integer from 1 to 4 on average.

In another variation of the present embodiment, the first polymer comprises segments 6 and 7:

E₁(SO₂X)_{d}—P₁-Q₁-P₂ 6

E₂-P₃-Q₂-P₄ 7

connected by a linking group L₁ to independently form polymer units 8 and 9:

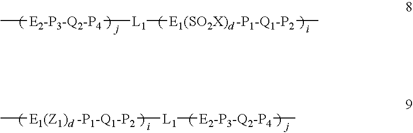

wherein:

Z₁ is a protogenic group such as —SO₂X, —PO₃H₂, —COX, and the like;

E₁ is an aromatic-containing moiety;

E₂ is an unsulfonated aromatic-containing and/or aliphatic-containing moiety;

L₁ is a linking group;

X is an —OH, a halogen, an ester, or

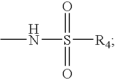

d is a number of Z₁ functional groups attached to E₁;

P₁, P₂, P₃, P₄ are each independently absent, —O—, —S—, —SO—, —SO₂—, —CO—, —NH—, NR₂—, —R₃—;

R₂ is C₁₋₂₅ alkyl, C₁₋₂₅ aryl or C₁₋₂₅ arylene;

R₃ is C₁₋₂₅ alkylene, C₁₋₂₅ perfluoroalkylene, or C₁₋₂₅ arylene;

R₄ is trifluoromethyl, C₁₋₂₅ alkyl, C₁₋₂₅ perfluoroalkylene, C₁₋₂₅ aryl, or another E₁ group;

Q₁, Q₂ are each independently a fluorinated cyclobutyl moiety;

i is a number representing the repetition of polymer segment 6 with i typically from 1 to 200; and

j is a number representing the repetition of a polymer with j typically from 1 to 200. In one refinement, d is equal to the number of aromatic rings in E₁. In another refinement, each aromatic ring in E₁ can have 0, 1, 2, 3, or 4 Z₁ groups.

In still another variation of the present embodiment, the first polymer comprises polymer segments 10 and 11:

E₁(Z₁)_{d}-P₁-Q₁-P₂ 10

E₂(Z₁)_{f}-P₃ 11

wherein:

Z₁ is a protogenic group such as —SO₂X, —PO₃H₂, —COX, and the like;

E₁, E₂ are each independently an aromatic or aliphatic-containing moiety wherein at least one of E₁ and E₂ include an aromatic substituted with Z₁;

X is an —OH, a halogen, an ester, or

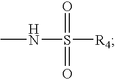

d is the number of Z₁ functional groups attached to E₁;

f is the number of Z₁ functional groups attached to E₂;

P₁, P₂, P₃ are each independently absent, —O—, —S—, —SO—, —SO₂—, —CO—, —NH—, NR₂—, or —R₃—;

R₂ is C₁₋₂₅ alkyl, C₁₋₂₅ aryl or C₁₋₂₅ arylene;

R₃ is C₁₋₂₅ alkylene, C₁₋₂₅ perfluoroalkylene, perfluoroalkyl ether, alkyl ether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁ is a fluorinated cyclobutyl moiety,

with the proviso that when d is greater than zero, f is zero and when f is greater than zero, d is zero. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average. In one refinement, f is equal to the number of aromatic rings in E₂. In another refinement, each aromatic ring in E₂ can have 0, 1, 2, 3, or 4 Z₁ groups. In still another refinement, f is an integer from 1 to 4 on average. In a variation, polymer segments 10 and 11 are each independently repeated 1 to 10,000 times to form respective polymer blocks that may be joined with a linking group L₁ shown below.

Example for Q₁ and Q₂ in the above formulae are:

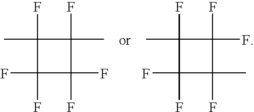

In each of the formulae 2-11, E₁ and E₂ include one or more aromatic rings. For example, E₁ and E₂, include one or more of the following moieties:

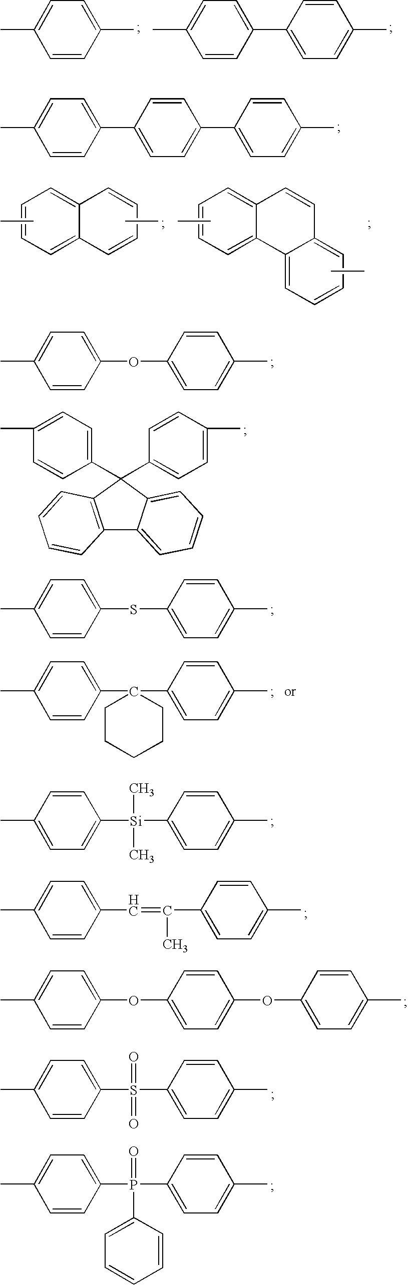

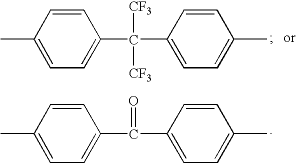

Examples of L₁ include the following linking groups:

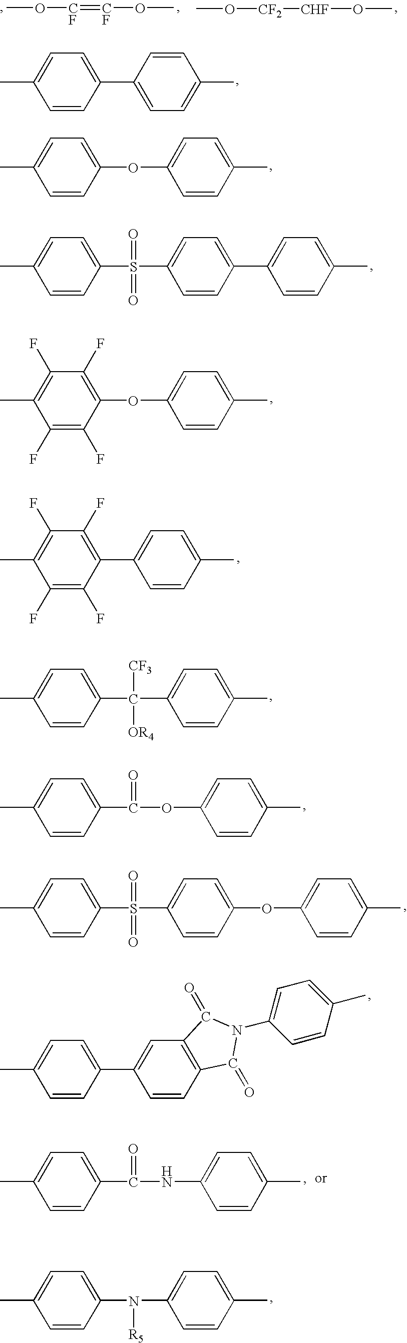

where R₅ is an organic group, such as an alkyl or acyl group.

In another embodiment of the present invention, polymeric membrane 26 includes a polymer blend. The polymer blend of this embodiment includes a first polymer and a second polymer. The first polymer includes the polymer segment 1 set forth above. The first polymer is different than the second polymer. In one variation, the second polymer is a non-ionic polymer. In a refinement, the non-ionic polymer is a fluorine-containing polymer such as a fluoro-elastomer or fluoro-rubber. The fluoro-elastomer may be any elastomeric material comprising fluorine atoms. The fluoro-elastomer may comprise a fluoropolymer having a glass transition temperature below about 25° C. or preferably, below 0° C. The fluoro-elastomer may exhibit an elongation at break in a tensile mode of at least 50% or preferably at least 100% at room temperature. The fluoro-elastomer is generally hydrophobic and substantially free of ionic group. The fluoro-elastomer may be prepared by polymerizing at least one fluoro-monomer such as vinylidene fluoride, tetrafluoroethylene, hexafluoropropylene, vinylfluoride, vinylchloride, chlorotrifluoroethylene, perfluoromethylvinyl ether, and trifluoroethylene. The fluoro-elastomer may also be prepared by copolymerizing at least one fluoro-monomer and at least one non-fluoro-monomer such as ethylene, propylene, methyl methacrylate, ethyl acrylate, styrene and the like. The fluoro-elastomer may be prepared by free radical polymerization or anionic polymerization in bulk, emulsion, suspension and solution. Examples of fluoro-elastomers include poly(tetrafluoroethlyene-co-ethylene), poly(vinylidene fluoride-co-hexafluoropropylene), poly(tetrafluoroethylene-co-propylene), terpolymer of vinylidene fluoride, hexafluoropropylene and tetrafluoroethylene, and terpolymer of ethylene, tetrafluoroethylene and perfluoromethylvinylether. Some of the fluoro-elastomers are commercially available from Arkema under trade name Kynar Flex® and Solvay Solexis under the trade name Technoflon®, from 3M under the trade name Dyneon®, and from DuPont under the trade name Viton®. For example, Kynar Flex 2751 is a useful copolymer of vinylidene fluoride and hexafluoropropylene with a melting temperature between about 130° C. and 140° C. The glass transition temperature of Kynar Flex 2751 is about −40 to −44° C. The fluoro-elastomer may further comprise a curing agent to allow crosslinking reaction after being blended with a first polymer that includes a perfluorocyclobutyl moiety.

In another variation of this embodiment, the second polymer is a perfluorosulfonic acid polymer (PFSA). In a refinement, such PFSAs are a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene.

In a variation of this embodiment, the second polymer is present in an amount from about 5 to about 70 weight percent of the total weight of the polymer blend. In a further refinement, the second polymer is present in an amount from about 10 to about 60 weight percent of the total weight of the polymer blend. In still another refinement, the polymer having polymer segment 1 is present in an amount from about 30 to about 95 weight percent of the total weight of the polymer blend. In still another refinement, the polymer having polymer segment 1 (i.e., the first polymer) is present in an amount from about 40 to about 90 weight percent of the total weight of the polymer blend.

The following examples illustrate the various embodiments of the present invention. Those skilled in the art will recognize many variations that are within the spirit of the present invention and scope of the claims.

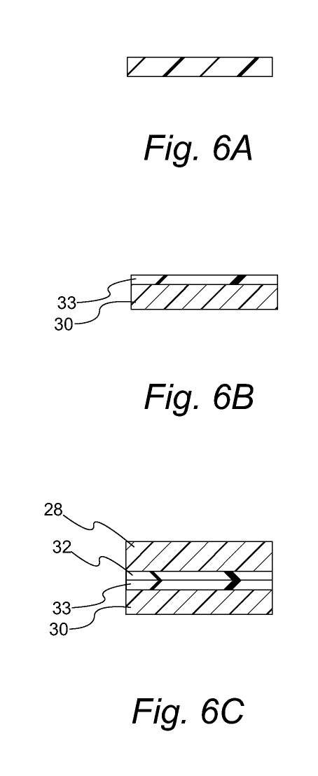

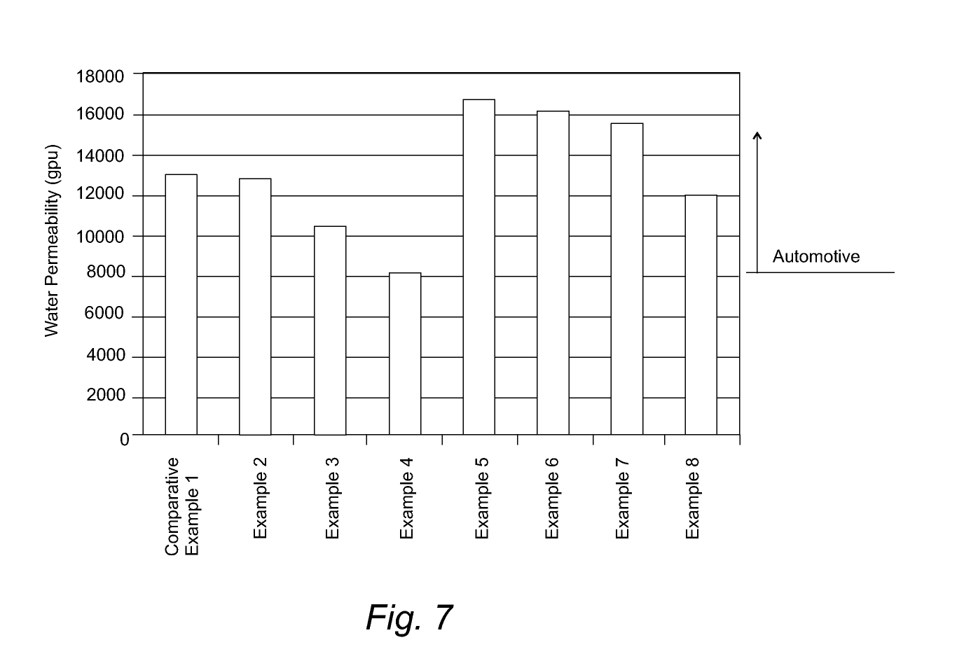

Table 1 and FIGS. 6A-C provide a set of membranes used to evaluate the performance of membrane humidifier assemblies made in accordance with embodiments set forth above. Example 1 corresponds to FIG. 6A with the polymeric membrane having a single selective layer of a PFSA polymer. Example 2 corresponds to FIG. 6B with polymeric substrate 30 being a Donaldson 1326 ePTFE support (D1326) and selective polymer layer 33 being a perfluorocyclobutyl polymer (PFCB) containing 0% Kynar Flex 2751 (KF). Example 3 corresponds to FIG. 6B with polymeric substrate 30 being a Donaldson 1326 ePTFE support and selective polymer layer 33 being a perfluorocyclobutyl polymer containing 40% Kynar Flex 2751. Example 4 corresponds to FIG. 6C with polymeric substrates 28, 30 being a Donaldson 1326 ePTFE support, selective polymer layers 32, 33 being a perfluorocyclobutyl polymer containing 0% Kynar Flex 2751, and selective polymer layers 32, 33 being a perfluorocyclobutyl polymer containing 40% Kynar Flex 2751. The two coated substrates are hot pressed together. Example 5 corresponds to FIG. 6B with polymeric substrate 30 being a Donaldson 1326 ePTFE support and selective polymer layer 33 being a perfluorocyclobutyl polymer containing 30% Kynar Flex 2751. Example 6 corresponds to FIG. 6B with polymeric substrate 30 being a Donaldson TX1316 ePTFE support (TX1316) and selective polymer layer 33 being a perfluorocyclobutyl polymer containing 30% Kynar Flex 2751. Example 7 corresponds to FIG. 6B with polymeric substrate 30 being a Donaldson 1326 ePTFE support and selective polymer layer 33 being a perfluorocyclobutyl polymer containing 30% Kynar Flex 2751. Example 8 corresponds to FIG. 6C with polymeric substrates 28 being a Donaldson 1326 ePTFE support, polymeric substrates 30 being a Donaldson TX1316 ePTFE support, and selective polymer layers 32, 33 each being a perfluorocyclobutyl polymer containing 30% Kynar Flex 2751. The two coated substrates are hot pressed together.

TABLE 1

| | | |
|---|---|---|
| Comparative | 25 μm PFSA baseline | main chain |
| Example 1 | | |
| Example 2 | Method 1 0% KF on D1326 | main chain |
| Example 3 | Method 1 40% KF on D1326, | main chain |
| | boiled | |
| Example 4 | Example 2 and 3 hot pressed | branched |
| Example 5 | Method 1 30% KF on D1326 | branched |
| Example 6 | Method 1 30% KF on TX1316 | branched |
| Example 7 | Method 2 30% KF on D1326 | branched |
| Example 8 | Example 5 and example 6 hot | branched |
| | pressed | |

### EXAMPLE 1

### PFSA Baseline

A membrane using a standard perfluorosulfonic acid polymer membrane is used as a baseline.

### EXAMPLE 2

### Method 1 Single Layer Composite

### Aryl Sulfonated Perfluorocyclobutyl Ionomer on Polytetrafluoroethylene Support Structure

A 5 wt % solution, in N,N-dimethylacetamide is prepared using a sulfonated segmented block copolymer (the PFCB ionomer) prepared from the reaction of chlorosulfonic acid with a perfluorocyclobutyl polymer (˜90,000 Mw) of a 16,000 Mw biphenyl perfluorocyclobutane oligomer and a hexafluoroisopropylidene-bis-trifluorovinyl ether monomer. A solution is prepared by dissolving 10 g of the PFCB ionomer in N,N-dimethylacetamide to yield a 5 wt % PFCB solution. The 5 wt % solution is then coated on a clean sheet of extruded Teflon® at 50° C. and the ePTFE support (for example, Donaldson 1326) is laid-down on top of the wet layer such that the solution is able to contact the porous support. The ePTFE structure remains opaque and the wet-film is dried over a 15 minute period. The resultant single layer composite membrane film is peeled from the clean sheet of extruded Teflon® and used as a water vapor transfer membrane in a membrane humidifier system suitable for use in a hydrogen-air fuel cell operated at less than 100° C.

### EXAMPLE 3

### Method 1 Single Layer Composite

### Aryl Sulfonated Perfluorocyclobutyl Ionomer 40% Kynar Flex Blend on Polytetrafluoroethylene Support Structure

A 5 wt % solution, in N,N-dimethylacetamide is prepared using a sulfonated segmented block copolymer (the PFCB ionomer) prepared from the reaction of chlorosulfonic acid with the perfluorocyclobutyl polymer (˜90,000 Mw) of a 16,000 Mw biphenyl perfluorocyclobutane oligomer and a hexafluoroisopropylidene-bis-trifluorovinyl ether monomer. A blend solution is prepared by adding 4 g of a 5 wt % solution of Kynar Flex 2751 in N,N-dimethylacetamide to 6 g of the 5 wt % PFCB solution. The 5 wt % solution is then coated on a clean sheet of extruded Teflon® at 50° C. and the ePTFE support (example, Donaldson 1326) is laid-down on top of the wet layer such that the solution is able to contact the porous support. The ePTFE structure remains opaque and the wet-film is dried over a 15 minute period. The resultant single layer composite membrane film is peeled from the clean sheet of extruded Teflon® and used as a water vapor transfer membrane in a membrane humidifier system suitable for use in a hydrogen-air fuel cell operated at less than 100° C.

### EXMAPLE 4

### Dual Layer Composite from Hot Press Lamination of Example 2 and Example 3 WVT Single Layer Membranes

Two single layer composites prepared from Method 1, specifically Example 2 and Example 3, are pressed at 120° C. and 4000 pounds for two minutes with the sides coated against the Teflon® layer in contact with each other. The resultant double layer composite membrane film is peeled from the clean sheet of extruded Teflon® and used as a water vapor transfer membrane in a membrane humidifier system suitable for use in a hydrogen-air fuel cell operated at less than 100° C.

### EXAMPLE 5

### Method 1 Single Layer Composite

### Perfluorocyclobutyl-Graft-Perfluorosulfonic Acid Ionomer 30% Kynar Flex Blend on Polytetrafluoroethylene Support Structure (Donaldson TX1316)

A 5 wt % solution, in N,N-dimethylacetamide is prepared using a perfluorocyclobutyl-graft-perfluorosulfonic acid (PFCB-g-PFSA) ionomer prepared from the reaction of the potassium salt of 2-(2-iodotetrafluoroethoxy)tetrafluoroethanesulfonyl fluoride, CAS#:[66137-74-4] with the aryl brominated perfluorocyclobutyl polymer (90,000 Mw) polymerized from a 16,000 Mw biphenyl perfluorocyclobutane oligomer and a hexafluoroisopropylidene-bis-trifluorovinyl ether monomer. A blend solution is prepared by adding 3 g of a 5 wt % solution of Kynar Flex 2751 in N,N-dimethylacetamide to 7 g of the 5 wt % PFCB-g-PFSA solution. The 5 wt % solution is then coated on a clean sheet of extruded Teflon® at 50° C. and the ePTFE support (example, Donaldson 1326) is laid-down on top of the wet layer such that the solution is able to contact the porous support. The ePTFE structure remains opaque and the wet-film is dried over a 15 minute period. The resultant single layer composite membrane film is peeled from the clean sheet of extruded Teflon® and used as a water vapor transfer membrane in a membrane humidifier system suitable for use in a hydrogen-air fuel cell operated at less than 100° C.

### EXAMPLE 6

### Method 1 Single Layer Composite

### Perfluorocyclobutyl-Graft-Perfluorosulfonic Acid Ionomer 30% Kynar Flex Blend on Polytetrafluoroethylene Support Structure (Donaldson TX1316)

A 5 wt % solution, in N,N-dimethylacetamide is prepared using a perfluorocyclobutyl-graft-perfluorosulfonic acid (PFCB-g-PFSA) ionomer prepared from the reaction of the potassium salt of 2-(2-iodotetrafluoroethoxy)tetrafluoroethanesulfonyl fluoride, CAS#:[66137-74-4] with the aryl brominated perfluorocyclobutyl polymer (90,000 Mw) polymerized from a 16,000 Mw biphenyl perfluorocyclobutane oligomer and a hexafluoroisopropylidene-bis-trifluorovinyl ether monomer. A blend solution is prepared by adding 3 g of a 5 wt % solution of Kynar Flex 2751 in N,N-dimethylacetamide to 7 g of the 5 wt % PFCB-g-PFSA solution. The 5 wt % solution is then coated on a clean sheet of extruded Teflon® at 50° C. and the ePTFE support (example, Donaldson TX1316) is laid-down on top of the wet layer such that the solution is able to contact the porous support. The ePTFE structure remains opaque and the wet-film is dried over a 15 minute period. The resultant single layer composite membrane film is peeled from the clean sheet of extruded Teflon® and used as a water vapor transfer membrane in a membrane humidifier system suitable for use in a hydrogen-air fuel cell operated at less than 100° C.

### EXAMPLE 7

### Method 2 Single Layer Composite

### Perfluorocyclobutyl-qraft-Perfluorosulfonic Acid Ionomer Blend on Polytetrafluoroethylene Support Structure (Donaldson 1326)

A 5 wt % solution, in N,N-dimethylacetamide is prepared using a perfluorocyclobutyl-graft-perfluorosulfonic acid (PFCB-g-PFSA) ionomer prepared from the reaction of the potassium salt of 2-(2-iodotetrafluoroethoxy)tetrafluoroethanesulfonyl fluoride, CAS#:[66137-74-4] with the aryl brominated perfluorocyclobutyl polymer (90,000 Mw) polymerized from a 16,000 Mw biphenyl perfluorocyclobutane oligomer and a hexafluoroisopropylidene-bis-trifluorovinyl ether monomer. A blend solution is prepared by adding 3 g of a 5 wt % solution of Kynar Flex 2751 in N,N-dimethylacetamide to 7 g of the 5 wt % PFCB-g-PFSA solution. The ePTFE support (example Donaldson 1326) is placed in contact with a clean sheet of extruded Teflon® at 50° C., wetted homogeneously with isopropanol and dried. The 5 wt % perfluorocyclobutyl ionomer blend solution is coated on the porous ePTFE support. The ePTFE structure remains opaque and the wet-film is dried over a 15 minute period. The resultant single layer composite membrane film is peeled from the clean sheet of extruded Teflon® and used as a water vapor transfer membrane in a membrane humidifier system suitable for use in a hydrogen-air fuel cell operated at less than 100° C.

### EXAMPLE 8

### Dual Layer Composite from Hot Press Lamination of Example 5 and Example 6 WVT Single Layer Membranes

Two single layer composites prepared from Method 1, specifically, Example 5 and Example 6, are pressed at 120° C. and 4000 lbs for two minutes with the sides coated against the Teflon® layer in contact with each other. The resultant double layer composite membrane film is peeled from the clean sheet of extruded Teflon® and used as a water vapor transfer membrane in a membrane humidifier system suitable for use in a hydrogen-air fuel cell operated at less than 100° C.

### Experimental Results

FIG. 7 provides experimental results at a common screening point for materials for water vapor transfer within a humidified, hydrogen-air fuel cell system. Grams of water transferred across the membrane are measured from a wet inlet stream of 80° C., 85% relative humidity, 10 slpm dry gas flow, and 160 kPaa to a dry inlet stream of 80° C., 0% relative humidity, 11.5 slpm dry gas flow, 80° C., and 183 kPaa. FIG. 7 also indicates acceptable levels for automotive fuel cell applications.

The above description of embodiments of the invention is merely exemplary in nature and, thus, variations thereof are not to be regarded as a departure from the spirit and scope of the invention.

What is claimed is:

1. A membrane humidifier for a fuel cell, the membrane humidifier comprising:
a first flow field plate adapted to facilitate flow of a first gas thereto;
a second flow field plate adapted to facilitate flow of a second gas thereto;
a polymeric membrane disposed between the first and second flow fields, the membrane adapted to permit transfer of water, the polymeric membrane comprising a polymeric substrate and a polymer layer disposed on the polymeric substrate, the polymer layer comprising a first polymer having fluorinated cyclobutyl groups disposed on the polymeric substrate.

2. The humidifier of claim 1 wherein the first gas and the second gas include a component selected from the group consisting of O₂, N₂, H₂O, H₂, and combinations thereof.

3. The humidifier of claim 1 wherein the polymeric membrane has a permeance of greater than 6000 GPU.

4. The humidifier of claim 1 wherein the first flow field plate and the second flow field plate each independently include a peripheral sealing section.

5. The humidifier of claim 1 wherein the first polymer layer is repeated from 1 to 10,000 times.

6. The humidifier of claim 1 wherein the first polymer layer includes a protogenic group selected from the group consisting of SO₂X, —PO₃H₂, and —COX and X is an —OH, a halogen, an ester, or 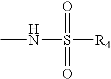
R₄ is trifluoromethyl, C₁₋₂₅ alkyl, C₁₋₂₅ perfluoroalkylene, or C₁₋₂₅ aryl.

7. The humidifier of claim 1 wherein the polymeric membrane comprises polymer segments 2 and 3:
[E₁(Z₁)_{d}]-P₁-Q₁-P₂ 2
E₂-P₃-Q₂-P₄ 3
wherein:
Z₁ is a protogenic group;
E₁ is an aromatic containing moiety;
E₂ is an unsulfonated aromatic-containing and/or aliphatic-containing moiety;
X is an —OH, a halogen, an ester, or 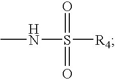
d is the number of Z₁ attached to E₁;
P₁, P₂, P₃, P₄ are each independently: absent, —O—, —S—, —SO—, —CO—, —SO₂—, —NH—, NR₃—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁, Q₂ are each independently a fluorinated cyclobutyl moiety.

8. The humidifier of claim 1 wherein the polymeric membrane comprises polymer segments 4 and 5: 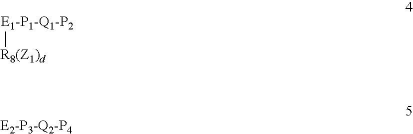
wherein:
Z₁ is a protogenic group;
E₁, E₂ are each independently an aromatic-containing and/or aliphatic-containing moiety;
X is an —OH, a halogen, an ester, or 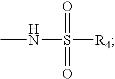
d is the number of Z₁ attached to R₈;
P₁, P₂, P₃, P₄ are each independently: absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
R₄ is trifluoromethyl, C₁₋₂₅ alkyl, C₁₋₂₅ perfluoroalkylene, C₁₋₂₅ aryl, or another E₁ group;
R₈(Z₁)_{d} is a moiety having d number of protogenic groups; and
Q₁, Q₂ are each independently a fluorinated cyclobutyl moiety.

9. The humidifier of claim 1 wherein the polymeric membrane comprises polymer segments 6 and 7:
E₁(SO₂X)_{d}—P₁-Q₁-P₂ 6
E₂-P₃-Q₂-P₄ 7
connected by a linking group L₁ to form polymer units 8 and 9: 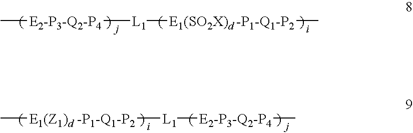
wherein:
Z₁ is a protogenic group;
E₁ is an aromatic-containing moiety;
E₂ is an unsulfonated aromatic-containing and/or aliphatic-containing moiety;
L₁ is a linking group;
X is an —OH, a halogen, an ester, or 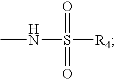
d is a number of Z₁ functional groups attached to E₁;
P₁, P₂, P₃, P₄ are each independently absent, —O—, —S—, —SO—, —SO₂—, —CO—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, or C₁₋₂₅ arylene;
R₄ is trifluoromethyl, C₁₋₂₅ alkyl, C₁₋₂₅ perfluoroalkylene, C₁₋₂₅ aryl, or another E₁ group;
Q₁, Q₂ are each independently a fluorinated cyclobutyl moiety;
i is a number representing the repetition of polymer segment 1; and
j is a number representing the repetition of a polymer segment 2.

10. The humidifier of claim 1 wherein the polymeric membrane comprises polymer segments 10 and 11:
E₁(Z₁)_{d}-P₁-Q₁-P₂ 10
E₂(Z₁)_{f}-P₃ 11
wherein:
Z₁ is a protogenic;
E₁, E₂ are each independently an aromatic or aliphatic-containing moiety wherein at least one of E₁ and E₂ include an aromatic substituted with Z₁;
X is an —OH, a halogen, an ester, or 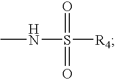
d is the number of Z₁ functional groups attached to R₈;
f is the number of Z₁ functional groups attached to E₂;
P₁, P₂, P₃ are each independently absent, —O—, —S—, —SO—, —SO₂—, —CO—, —NH—, NR₂—, —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkyl ether, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁ is a fluorinated cyclobutyl moiety,
with the proviso that when d is greater than zero, f is zero and when f is greater than zero d is zero.

11. The humidifier of claim 1 wherein the polymeric membrane further comprises a second polymer that is blended with the first polymer to form a polymeric blend.

12. The humidifier of claim 11 wherein the second polymer is a fluoroelastomer.

13. The humidifier of claim 11 wherein the second polymer is PFSA polymer.

14. The humidifier of claim 11 wherein the first polymer is present in an amount from about 30 to about 95 weight percent of the total weight of the polymeric blend.

15. A fuel cell system comprising:
a fuel cell stack having a cathode side and an anode side;
a membrane humidifier comprising:
a first flow field plate adapted to receive a first gas from the cathode side of the fuel cell stack;
a second flow field plate adapted to facilitate flow of a second gas thereto;
a polymeric membrane disposed between the first and second flow fields, the membrane adapted to permit transfer of water, the polymeric membrane comprising a polymeric substrate and a polymer layer disposed on the polymeric substrate, the polymer layer comprising a first polymer having a polymer segment comprising polymer segment 1:
E₀-P₁-Q₁-P₂ 1
wherein:
Eₒ is a moiety having a protogenic group;
P₁, P₂ are each independently absent, —O—, —S—, —SO—, —CO—, —SO₂—, —NR₁H—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene; and
Q₁ is a fluorinated cyclobutyl moiety.

16. The fuel cell system of claim 15 wherein the first gas and the second gas include a component selected from the group consisting of O₂, N₂, H₂O, H₂, and combinations thereof.

17. The fuel cell system of claim 15 wherein the polymeric membrane has a permeance of greater than 6000 GPU.

18. The fuel cell system of claim 15 wherein the first flow field plate and the second flow field plate each independently include a peripheral sealing section.

19. The fuel cell system of claim 15 wherein polymer segment 1 is repeated from 1 to 10,000 times.

20. The fuel cell system of claim 15 wherein the protogenic group is —SO₂X, —PO₃H₂, or —COX;
X is an —OH, a halogen, an ester, or 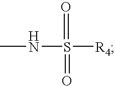
and
R₄ is trifluoromethyl, C₁₋₂₅ alkyl, C₁₋₂₅ perfluoroalkylene, C₁₋₂₅ aryl, or E₁(see below),
